(19) United States
(12) Patent Application Publication
(10) Pub. No.: US 2018/0313452 A1
(43) Pub. Date: Nov. 1, 2018

(54) FRICTION DETENT APPARATUS

(71) Applicant: NORCAN FLUID POWER LTD., North Vancouver (CA)

(72) Inventor: Doug P. Almond, Langley (CA)

(21) Appl. No.: 15/963,775

(22) Filed: Apr. 26, 2018

(30) Foreign Application Priority Data
Apr. 27, 2017 (CA) 2965267

(51) Int. Cl. F16K 11/07; F16K 35/04; F15B 13/04

(52) U.S. Cl. CPC F16K 11/0704; F15B 13/0402; F16K 11/0716; F16K 35/04

(57) ABSTRACT

There is disclosed a friction detent apparatus for use in hydraulic spool valve assemblies. In an embodiment, the apparatus comprises: a detent plunger; a friction tube adapted to fit over at least one recessed section of the detent plunger; and an adjustable friction collar adapted to slidingly engage an outer surface of the friction tube and to provide frictional resistance to movement of the detent plunger in an axial direction. The linear frictional resistance provided by the friction detent apparatus provides smoother operation of a hand lever mechanically connected to the detent plunger via a main spool of a hydraulic spool valve within the hydraulic spool valve assembly, and the amount of linear frictional resistance can be adjusted independently from any detent breakout force.

### BACKGROUND

### Field of the Invention

The present invention relates generally to a friction detent apparatus for use in hydraulic spool valve assemblies.

### Description of the Related Art

Detent mechanisms are used to mechanically resist or arrest the rotation or linear motion of a part, such as an irregular shaped wheel or a plate, or a spool having one or more detent positions. As an illustrative example, one application of a detent mechanism is within a hydraulic spool valve assembly to provide resistance to operation of a hand lever. The detent mechanism may include a detent compression spring which apply a force against one or more detent balls to provide resistance during operation of the hand lever.

However, a drawback of compression spring detent mechanisms is that they tend to require greater dexterity on the part of the operator of hand levers in order to maintain control, particularly where the hand levers are employed to operate and control movement of sophisticated heavy machinery, such as drilling equipment, cranes, tractors of the like.

What is needed is an improved detent mechanism which addresses at least some of the limitations and drawbacks in the prior art.

### BRIEF SUMMARY

The present invention relates to an improved friction detent apparatus for use in hydraulic spool valve assemblies.

In an aspect, the friction detent apparatus comprises a detent plunger, a friction tube adapted to fit over at least one recessed section of the detent plunger, and an adjustable friction collar adapted to slidingly engage the friction tube fitted over the detent plunger. One or more adjustable retaining rings are used to apply pressure radially on the adjustable friction collar to mechanically engage the friction tube from all sides.

In operation, the friction tube fitted over at least one recessed section of the detent plunger moves axially with the detent plunger, and slidingly engages a stationary friction collar in order to provide frictional resistance to movement of the detent plunger in an axial direction. Advantageously, the frictional resistance provides smoother operation of a hand lever mechanically connected to the detent plunger via a main spool of a hydraulic spool valve assembly.

In an embodiment, a detent sleeve is sized and shaped to receive a forward end of the detent plunger. The detent plunger is adapted to house a detent compression spring which applies force against an axially displaced detent ball. The axially displaced detent ball is adapted to redirect the axial force of the detent compression spring against a plurality of smaller radially displaced detent balls held within suitably sized apertures positioned around the forward end of the detent plunger. The smaller radially displaced detent balls are pushed outward radially to engage the inner walls of the detent sleeve.

In another embodiment, the detent sleeve includes a detent groove along an inner wall of the detent sleeve. When the smaller radially displaced detent balls engage the detent groove, the detent plunger is temporarily held in that detent position, requiring a somewhat greater force to disengage the radially displaced detent balls from the detent groove. This translates to an operator feeling a hand lever connected to the hydraulic spool valve assembly engage into a set position, which requires a somewhat greater force on the hand lever to disengage.

In another embodiment, the adjustable friction collar includes a longitudinal break along its entire length, such that the adjustable friction collar may be temporarily widened to fit over the friction tube. The material used for the adjustable friction collar may be a flexibly resilient material to retain its shape. For example, the flexibly resilient material of the friction tube may be a nylon material with deformation characteristics allowing for some variation in the outer dimension of the recessed section of the detent plunger.

In another embodiment, the friction tube material is selected to withstand operating temperatures of between about −20° C. to about +80° C. without significant changes in performance characteristics. The friction tube is replaceable if it wears down over a significant period of time due to use.

In another embodiment, the retaining ring may also include a break along its length to be temporarily widened to fit over a section of the adjustable friction collar. The material used for the retaining ring may also be a flexibly resilient material to retain its shape.

Advantageously, the amount of linear frictional detent force generated between the adjustable friction collar and the friction tube when they move axially relative to each other may be independently adjusted from any detent breakout force by selecting the number and type of retaining rings used.

In this respect, before explaining at least one embodiment of the invention in detail, it is to be understood that the invention is not limited in its applications to the details of construction and to the arrangements of the components set forth in the following description or the examples provided therein, or illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE SEVERAL VIEWS OF THE DRAWINGS

FIG. 1 shows an exploded view of a friction detent apparatus in accordance with an illustrative embodiment.

FIG. 2 shows a cross-sectional view of an assembled friction detent apparatus in accordance with an illustrative embodiment.

FIGS. 3A to 3C show detailed views of a friction tube in accordance with an illustrative embodiment.

FIGS. 4A to 4C shows detailed views of a friction collar in accordance with an illustrative embodiment.

### DETAILED DESCRIPTION

As noted above, the present invention relates to an improved friction detent apparatus for use in hydraulic spool valve assemblies.

An illustrative embodiment will now be described with reference to the drawings.

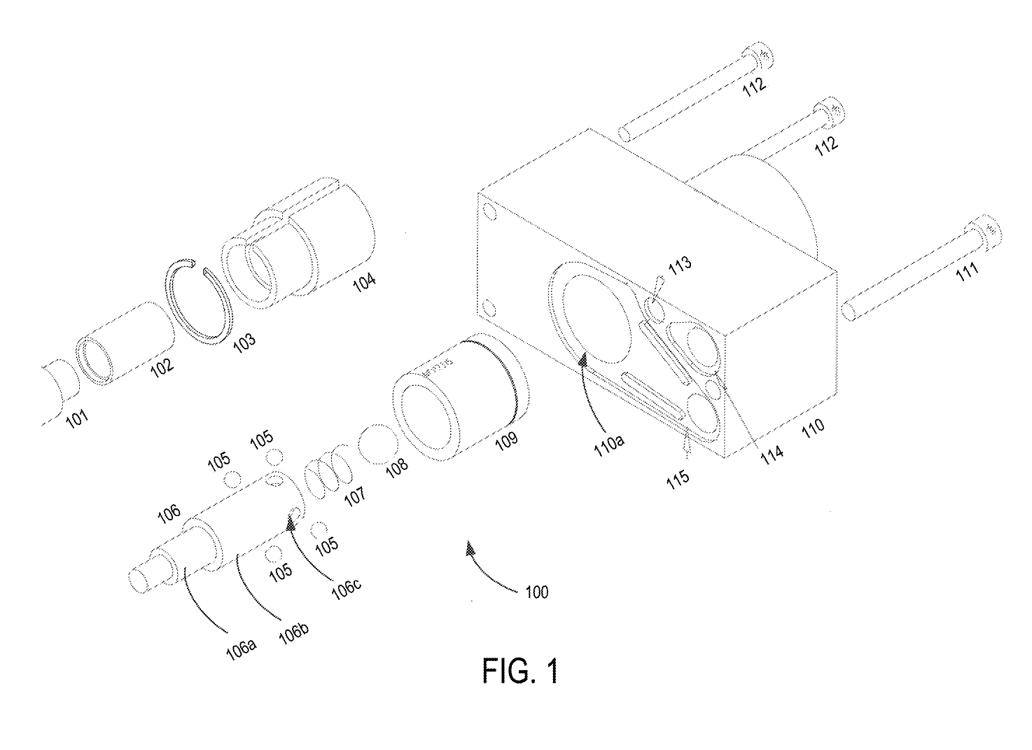

FIG. 1 shows an exploded view of a friction detent apparatus 100 in accordance with an illustrative embodiment. As shown at left, friction detent apparatus 100 may include a friction tube 102 adapted to couple to a valve spool 101 of a hydraulic spool valve (not shown). A retaining ring 103 is employed to secure friction collar 104 over friction tube 102 as will be described in more detail further below.

Still referring to FIG. 1, a detent plunger 106 includes a recessed section 106a over which friction tube 102 is fitted. The largest section 106b of detent plunger 106 further includes a plurality of apertures 106c for receiving a plurality of radially displaced smaller detent balls 105, as will be explained in more detail further below. Detent plunger 106 is adapted to receive a detent compression spring 107 within the largest section 106b, which detent compression spring 107 applies a force against a larger detent ball 108 which is axially displaced.

Still referring to FIG. 1, a detent sleeve 109 is sized and shaped to abut friction collar 104, but to receive detent plunger 106 therein. The detent sleeve 109 itself is received within a corresponding recess 110a of detent cover 110. Mounting screws 111, 112 are used to mount cover 110 to an adjacent surface of a hydraulic spool valve assembly (not shown), with various o-rings 112, 114, 115 sized and shaped to seal shallow recessed sections of the detent cover 110.

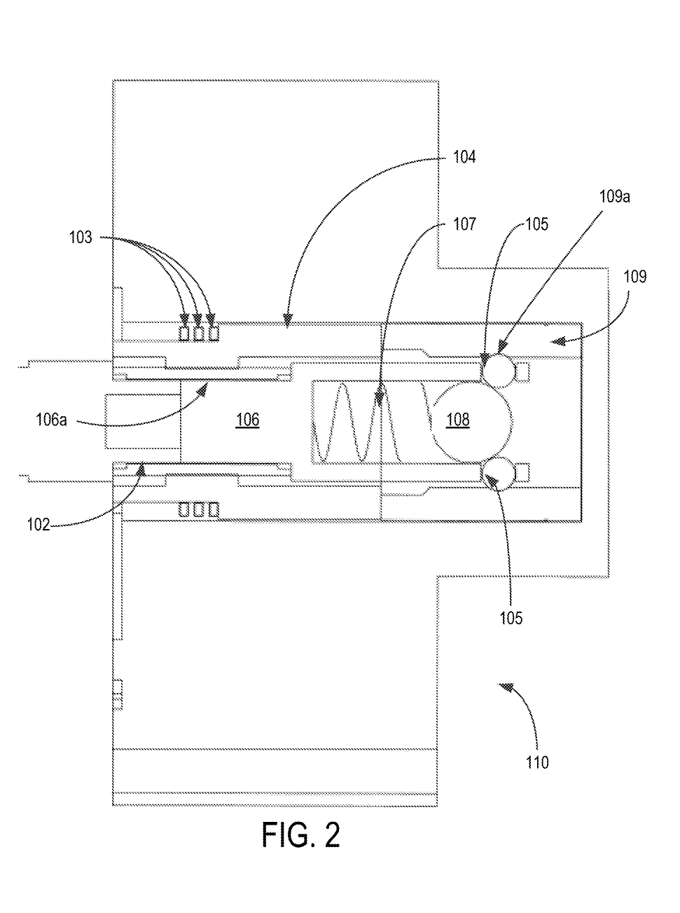

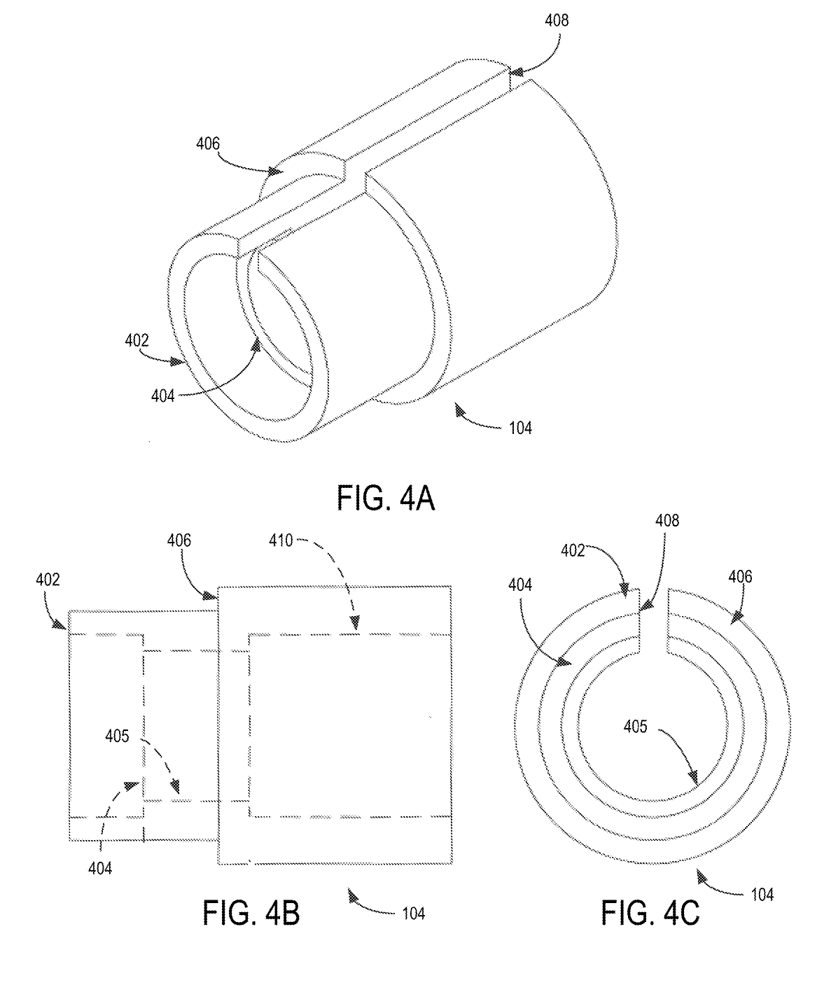

Now referring to FIG. 2, shown is a cross-sectional view of an assembled friction detent apparatus in accordance with an illustrative embodiment. Like parts are labeled using the same reference numerals as in FIG. 1. As shown in FIG. 2, when assembled, a recessed section 106a of detent plunger 106 is covered by friction tube 102, and friction tube 102 engages an inner section of adjustable friction collar 104. The amount of frictional force between the adjustable friction collar 104 and the friction tube 102 may be varied by selecting the number and type of retaining ring 103 used. In operation, the friction tube 102 fitted over at least one recessed section 106a of the detent plunger 106 moves axially with the detent plunger 106, and slidingly engages an inner surface 405 (see FIG. 4C) of stationary friction collar 104 in order to provide dynamic frictional resistance to movement of the detent plunger 106, whether forwards or backwards in an axial direction.

Advantageously, the linear frictional resistance provided by the friction detent apparatus 100 provides smoother operation of a hand lever mechanically connected to the detent plunger via a main spool of a hydraulic spool valve within the hydraulic spool valve assembly (not shown), and the amount of linear frictional resistance can be adjusted independently from any detent breakout force by selecting the number and type of retaining rings used.

In an embodiment, a detent sleeve 109 is sized to receive a leading end of the detent plunger 106. The detent plunger 106 is adapted to house a detent compression spring 107 and an axially displaced detent ball 108 adapted to redirect the axial force of the detent compression spring 107 into a force directed radially against a plurality of smaller radially displaced detent balls 105 held within suitably sized apertures 106c positioned around the largest section of the detent plunger 106. The smaller radially displaced detent balls 105 are pushed outward radially to engage the inner walls of the detent sleeve 109.

In an embodiment, the detent sleeve 109 includes a detent groove 109a along an inner wall of the detent sleeve 109. When the smaller radially displaced detent balls 105 engage the detent groove 109a, the detent plunger 106 is temporarily held in a detent position requiring a somewhat greater force to disengage the radially displaced detent balls 105 from the detent groove 109a. This translates to an operator feeling a hand lever connected to the hydraulic spool valve assembly engage into a set position, which requires a somewhat greater force on the hand lever to disengage.

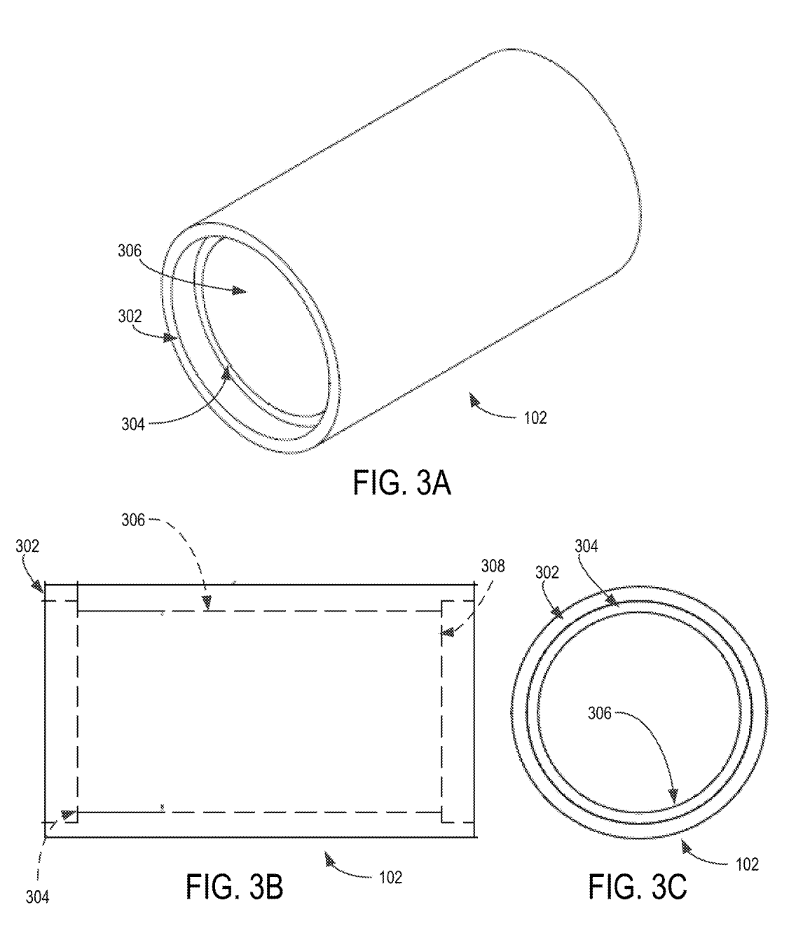

Now referring to FIGS. 3A to 3C, shown are detailed views of friction tube 102 in accordance with an illustrative embodiment. As shown, friction tube 102 is generally tubular in shape, and has a defined outer edge 302. In an embodiment, friction tube 102 further includes a recessed inner ledge 304, and an inner surface 306 adapted to engage an outer surface of a recessed section of detent plunger 106.

In an embodiment, the friction tube 102 may be made from a heat treated metal. By way of illustrative example, and not by way of limitation, the heat treated metal may be 4140 HTSR. It will be appreciated, however, that other types of heat treated metal could be used.

Now referring to FIGS. 4A to 4C, shown are detailed views of adjustable friction collar 104 in accordance with an illustrative embodiment. As shown, adjustable friction collar 104 includes an outer edge 402 and a recessed inner ledge 404. As previously described, an inner surface 405 of the narrowest section of friction collar 104 is adapted to frictionally engage an outer surface of friction tube 102. A longitudinal break 408 is provided along its entire length, such that the adjustable friction collar 104 can be widened to fit over the friction tube 102. The amount of frictional force between the adjustable friction collar 104 and the friction tube 102 may be varied by selecting the number and type of retaining rings 103 used to secure the adjustable friction collar 104.

The adjustable friction collar 104 may be made of a resiliently flexible material in order to allow adjustable friction collar 104 to return to a default position when not stretched out over a friction tube 102 or squeezed smaller by one or more retaining rings 103.

For example, the flexibly resilient material of the adjustable friction collar 104 may be a nylon material with deformation characteristics allowing for some variation in the outer diameter of the friction tube 102, and the inner diameter of the adjustable friction collar 104. By way of illustrative example only, and not by way of limitation, the nylon material may be NYCAST 6PA, manufactured by Cast Nylons Limited of Ohio, USA. It will be appreciated that other types of nylon material may be used for the adjustable friction collar.

In another embodiment, the flexibly resilient material for the adjustable friction collar 104 is selected to withstand operating temperatures of between about −20° C. to about +80° C. The flexibly resilient material is selected for acceptable performance throughout the operating temperature range.

Thus, in an aspect, there is provided a friction detent apparatus for use in hydraulic spool valve assemblies, comprising: a detent plunger; a friction tube adapted to fit over at least one recessed section of the detent plunger; and an adjustable friction collar adapted to slidingly engage an outer surface of the friction tube and to provide frictional resistance to movement of the detent plunger in an axial direction.

In an embodiment, the friction detent apparatus further comprises a detent sleeve sized and shaped to receive a forward end of the detent plunger.

In another embodiment, the friction detent apparatus further comprises: a detent compression spring housed in the detent plunger; a first detent ball housed in the detent plunger and pressed forward axially by the detent compression spring; and a plurality of smaller detent balls held within suitably sized apertures positioned around the forward end of the detent plunger; wherein, the first detent ball when pressed forward axially by the detent compression spring is adapted to engage and to press the plurality of smaller detent balls outward radially to engage the inner walls of the detent sleeve.

In another embodiment, the detent sleeve includes a detent groove along an inner wall of the detent sleeve, the detent groove adapted to receive and temporarily hold the plurality of smaller detent balls in a detent position.

In another embodiment, the detent plunger is a heat treated metal material.

In another embodiment, the friction tube is a heat treated metal material.

In another embodiment, the adjustable friction collar includes a longitudinal break along its entire length, and is adapted to be temporarily widened to fit over the friction tube.

In another embodiment, the material used for the adjustable friction collar is a flexibly resilient material adapted to retain its shape.

In another embodiment, the flexibly resilient material of the friction collar is a nylon material.

In another embodiment, the flexibly resilient material is selected to withstand operating temperatures of between about −20° C. to about +80° C.

In another embodiment, the friction detent apparatus further comprises one or more adjustable retaining rings to apply pressure radially on the adjustable friction collar.

In another embodiment, the retaining ring includes a break along its length and is adapted to be temporarily widened to fit over a section of the adjustable friction collar.

In another embodiment, the material used for the retaining ring is a flexibly resilient material to retain its shape.

In another embodiment, the flexibly resilient material of the retaining ring is a heat treated metal material.

In another embodiment, the amount of frictional resistance provided by the adjustable friction collar is variable based on the number and type of retaining rings used.

While various illustrative embodiments have been described above by way of example, it will be appreciated that various changes and modifications may be made without departing from the scope of the invention, which is defined by the following claims.

The various implementations described above can be combined to provide further embodiments. Aspects of the implementations can be modified, if necessary to provide yet further embodiments.

These and other changes can be made to the embodiments in light of the above-detailed description. In general, in the following claims, the terms used should not be construed to limit the claims to the specific implementations disclosed in the specification and the claims, but should be construed to include all possible implementations along with the full scope of equivalents to which such claims are entitled. Accordingly, the claims are not limited by the disclosure.

1. A friction detent apparatus for use in hydraulic spool valve assemblies, comprising:
a detent plunger;
a friction tube adapted to fit over at least one recessed section of the detent plunger; and
an adjustable friction collar adapted to slidingly engage an outer surface of the friction tube and to provide frictional resistance to movement of the detent plunger in an axial direction.

2. The friction detent apparatus of claim 1, further comprising a detent sleeve sized and shaped to receive a forward end of the detent plunger.

3. The friction detent apparatus of claim 2, further comprising:
a detent compression spring housed in the detent plunger;
a first detent ball housed in the detent plunger and pressed forward axially by the detent compression spring; and
a plurality of smaller detent balls held within suitably sized apertures positioned around the forward end of the detent plunger;
wherein, the first detent ball when pressed forward axially by the detent compression spring is adapted to engage and to press the plurality of smaller detent balls outward radially to engage an inner wall of the detent sleeve.

4. The friction detent apparatus of claim 3, wherein the detent sleeve includes a detent groove along the inner wall of the detent sleeve, the detent groove adapted to receive and temporarily hold the plurality of smaller detent balls in a detent position.

5. The friction detent apparatus of claim 1, wherein the detent plunger is a heat treated metal material.

6. The friction detent apparatus of claim 1, wherein the friction tube is a heat treated metal material.

7. The friction detent apparatus of claim 1, wherein the adjustable friction collar includes a longitudinal break along its entire length, and is adapted to be temporarily widened to fit over the friction tube.

8. The friction detent apparatus of claim 7, wherein the material used for the adjustable friction collar is a flexibly resilient material adapted to retain its shape.

9. The friction detent apparatus of claim 8, wherein the flexibly resilient material of the friction collar is a nylon material.

10. The friction detent apparatus of claim 8, wherein the flexibly resilient material is selected to withstand operating temperatures of between about −20° C. to about +80° C.

11. The friction detent apparatus of claim 1, further comprising one or more adjustable retaining rings to apply pressure radially on the adjustable friction collar.

12. The friction detent apparatus of claim 11, wherein the retaining ring includes a break along its length and is adapted to be temporarily widened to fit over a section of the adjustable friction collar.

13. The friction detent apparatus of claim 12, wherein the material used for the retaining ring is a flexibly resilient material to retain its shape.

14. The friction detent apparatus of claim 13, wherein the flexibly resilient material of the retaining ring is a heat treated metal material.

15. The friction detent apparatus of claim 11, wherein the amount of frictional resistance provided by the adjustable friction collar is variable based on the number and type of retaining rings used.
